(19) United States
(12) Patent Application Publication
(10) Pub. No.: US 2012/0006485 A1
(43) Pub. Date: Jan. 12, 2012

(54) SUBSTRATE TREATMENT DEVICE

(76) Inventor: Makoto Tanabe, Osaka (JP)

(21) Appl. No.: 13/147,353

(22) PCT Filed: Jan. 29, 2010
(86) PCT No.: PCT/JP2010/051228

§ 371 Date: Aug. 1, 2011

(30) Foreign Application Priority Data
Feb. 2, 2009 (JP) 2009-021201

(51) Int. Cl. B08B 13/00; B08B 3/04

(52) U.S. Cl. 156/345.11; 134/104.2

(57) ABSTRACT

A substrate treatment device including a cleaning chamber that is capable of decreasing a thick waste solution from the chamber, and improving use efficiency of a diluted waste solution from the chamber. The chamber supplies a cleaning solution onto a front surface of a chemical-treated substrate being transferred tilted toward its back surface side at some degrees to the upright by a cleaning-solution discharge unit. The chamber is partitioned into rough and fine cleaning chambers (103) (104) at upstream and downstream sides, each having vents on bottom walls, with a partition standing on the bottom wall, the rough chamber including a gutter (112) collecting the solution discharged from the discharge unit and falling down without being supplied onto the front surface, the gutter inclined down toward the fine chamber and having a vent draining the solution flowing therethrough, the gutter's vent approaching the fine chamber across the partition.

### TECHNICAL FIELD

The present invention relates to a substrate treatment device that supplies a chemical solution or a cleaning solution to a substrate such as a glass substrate for a liquid crystal display panel while transferring the substrate.

### BACKGROUND ART

A liquid crystal display panel is in widespread use for a display unit of a home electrical appliance such as a computer and a television. In general, the liquid crystal display panel includes a pair of glass substrates consisting of a thin film transistor (TFT) substrate and a color filter (CF) substrate that are opposed to each other having a given space therebetween, and liquid crystals that are filled between the substrates.

For example, in producing a TFT substrate, a glass substrate undergoes in sequence a film deposition process, a resist coating process, an exposure process, a resist processing process, an etching process and a resist removal process, whereby a TFT is formed on the glass substrate.

In order to form a TFT circuit on the glass substrate, a metal film is formed on the glass substrate by the film deposition process, and then the metal film is subjected to the etching process so as to have a given pattern. A resist that is a photosensitive resin is used as a mask for the etching process. After the etching process, the resist is removed there from by the resist removal process.

A resist removing device is used in the resist removal process, which discharges a removal solution in a showering manner onto a front surface and back surface of the glass substrate. A generally-used resist removing device includes a plurality of aligned removal chambers. A plurality of glass substrates are transferred one by one from a neutral chamber to the aligned removal chambers in sequence. The glass substrates undergo the resist removal process using the removal solution, and are then transferred to a cleaning chamber to undergo a water washing process using pure water. During these processes, the glass substrates are transferred from the neutral chamber, which is located at the most upstream side in the resist removing device, toward the cleaning chamber, which is located at the most downstream side, via the removal chambers.

FIG. 7 is a front view showing a schematic configuration of a removal chamber 90 and a cleaning chamber 100 of a resist removing device 201. FIG. 8 is a cross-sectional view showing the cleaning chamber 100 along the line B-B of FIG. 7. The resist removing device 201 is arranged to perform resist removal while transferring glass substrates 2 that are tilted toward their back surface 2b sides at fifteen degrees to the upright, in other words, at seventy-five degrees from the horizontal direction as shown in FIG. 8. As shown in FIG. 7, the removal chamber 90 and the cleaning chamber 100 are partitioned with a partition wall 101 that has a slit opening 101a allowing passage of a substrate.

A removal solution discharge bar 7 arranged to supply a removal solution onto front surfaces 2a and back surfaces 2b of the glass substrates 2 is provided to the removal chamber 90. Air blowing bars 12 are provided at the upstream side and downstream side of the slit opening 101a. High-pressure air is issued from the air blowing bars 12 to remove the removal solution adhered to the front surfaces 2a and back surfaces 2b of the glass substrates 2. Thus, the removal solution is prevented from getting in the adjacent cleaning chamber 100.

As shown in FIG. 7, the cleaning chamber 100 includes a rough cleaning chamber 103 at the upstream side and a fine cleaning chamber 104 at the downstream side, which are partitioned with a partition 106 provided to stand on a bottom wall 105. Each of the cleaning chambers 103 and 104 includes two pure water discharge bars 18 disposed at the front side that are arranged to supply pure water 5 onto the front surfaces 2a of the glass substrates 2, and one pure water discharge bar 19 disposed at the back side that is arranged to supply pure water 5 onto the back surfaces 2b of the glass substrates 2. A plurality of nozzles 18a and 19a that are arranged to discharge the pure water 5 in a showering manner are provided to the pure water discharge bars 18 and 19, respectively.

In addition, each of the cleaning chambers 103 and 104 includes support rollers 9, which are arranged to support the back surfaces 2b of the glass substrates 2, and transfer rollers 10 disposed in a direction in which the glass substrates 2 are transferred, which are arranged to transfer the glass substrates 2 while supporting the lower ends of the glass substrates 2, as shown in FIGS. 7 and 8.

The support rollers 9 are disposed at the side of the back surfaces 2b that is under the tilted glass substrates 2. The axes of the support rollers 9 are tilted so as to be parallel to the glass substrates 2 being transferred, in other words, tilted at seventy-five degrees. As shown in FIGS. 7 and 8, the support rollers 9 are rotatable about roller axes 9a by ball bearings 9b. The upper ends and lower ends of the roller axes 9a are fixed to an upper wall 107 and lower wall 108 of the cleaning chamber 100. The roller axes 9a are disposed at given intervals in the transfer direction.

Intermediate portions of the roller axes 9a are supported by the front ends of roller-axis support plates 110 that are disposed to stand on a back wall 109 of the cleaning chamber 100. Thus, the roller axes 9a are prevented from getting eccentric, whereby the roller axes 9 are not decentered during the transfer of the substrates 2. Each of the roller-axis support plates 110 includes a plurality of openings 110a that allow passage of the pure water 5 falling down on the back wall 109 of the cleaning chamber 100, as shown in FIG. 9. The pure water 5 that falls down on the back wall 109 or front wall 111 of the cleaning chamber 100 is discharged from drainage vents 21 and 22 provided on the bottom wall 105 of the cleaning chambers 103 and 104.

The transfer rollers 10 arranged to support the lower ends of the glass substrates 2 are fixed to one ends of drive axes 10a. Gears 10b are attached to the other ends of the drive axes 10a. Gears 11b having a configuration to engage with the gears 10b are attached to rotational axes 11a of motors 11. Rotary driving the transfer rollers 10 by the use of the motors 11 generates a friction force between the transfer rollers 10 and the lower ends of the glass substrates 2, which allows the glass substrates 2 to be transferred.

From the air blowing bars 12 disposed at the upstream side of the partition wall 101, air is issued to the front surfaces 2a and back surfaces 2b of the glass substrates 2 being transferred from the removal chamber 90 to the cleaning chamber 100. Thus, the adhered removal solution is removed therefrom.

In general, during the removal of the removal solution with the use of the air blowing bars 12, the pressure of the issued air cannot be increased much in case the glass substrates 2 are widely bent to be brought into contact with the slit opening 101a of the partition wall 101. For this reason, a considerable amount of the removal solution remains adhered to the front surfaces 2a and back surfaces 2b of the glass substrates 2, and gets in the adjacent cleaning chamber 100 together with the glass substrates 2.

The removal solution getting in the cleaning chamber 100 produces a mixture (thick waste solution) H of the removal solution and the pure water 5 where the mixing ratio of the removal solution is high in the rough cleaning chamber 103 at the upstream side. Meanwhile, in the fine cleaning chamber 104 at the downstream side, because the removal solution is removed to some extent in the rough cleaning chamber 103, a mixture (diluted waste solution) L of the removal solution and the pure water 5 where the mixing ratio of the removal solution is low is produced.

In general, the thick waste solution H collected from the drainage vent 21 of the rough cleaning chamber 103 is disposed of. To be specific, the thick waste solution H is boiled in a boiler to be made into powdery wastage, and then is disposed of. Meanwhile, the diluted waste solution L collected from the drainage vent 22 of the fine cleaning chamber 104, of which the removal solution ingredient is relatively easily removed therefrom preferably by bacteria, is recycled as the pure water 5 to be used in the cleaning chamber 100. As shown in FIG. 1, the diluted waste solution L is once collected into a recovery tank 25, cleaned there preferably by bacteria, and returned to the pure water discharge bars 18 and 19 via a pump 26 and a filter 27. See PTL1.

### CITATION LIST

### Patent Literature

PTL 1: JP2004-6631

### SUMMARY OF INVENTION

### Technical Problem

However, there arises a problem. During passage of the glass substrates 2 between the pure water discharge bars 18 and 19 in the rough cleaning chamber 103, the discharged pure water 5 is mixed with the removal solution that remains on the front surfaces 2a and back surfaces 2b of the glass substrates 2, and the thick waste solution H thereof is drained out of the drainage vent 21 on the bottom wall 105 in the rough cleaning chamber 103 as shown in FIG. 8. Meanwhile, during the time from when upper ends 2c of the glass substrates 2 pass between the pure water discharge bars 18 and 19 until when lower ends 2d of the following glass substrates 2 are transferred to the position where the pure water discharge bars 18 and 19 are located, the discharged pure water 5 falls down on the back wall 109 or front wall 111 without being supplied to the glass substrates 2 as shown in FIGS. 7 and 9.

Containing very little removal solution, the pure water 5 falling down on the back wall 109 or front wall 111 without being supplied to the glass substrates 2 is drained out of the drainage vent 21 of the bottom wall 105. This drained pure water 5 dilutes the thick waste solution H that has been drained already, so that the amount of thick waste solution H to be boiled in a boiler for disposal is increased, which causes an increase in cost.

In order to overcome the problems described above, one preferred embodiment of the pre sent invention provides a substrate treatment device that includes a cleaning chamber arranged to supply a cleaning solution such as pure water to a chemical-treated substrate, is capable of decreasing the amount of a thick waste solution drained out of the cleaning chamber, and improving use efficiency of a diluted waste solution that is collected from the cleaning chamber.

### Solution to Problem

A preferred embodiment of the present invention provides a substrate treatment device that includes a cleaning chamber including a substrate transferring unit arranged to transfer a substrate while keeping the substrate tilted toward a back surface side of the substrate at a given degree to the upright, and a cleaning solution discharge unit arranged to supply a cleaning solution onto a front surface of the substrate being transferred by the substrate transferring unit, wherein the cleaning chamber is partitioned into a rough cleaning chamber at an upstream side that includes a drainage vent disposed on the bottom wall of the rough cleaning chamber and a fine cleaning chamber at a downstream side that includes a drainage vent provided on a bottom wall of the fine cleaning chamber with a partition provided to stand on a bottom wall of the cleaning chamber, wherein the rough cleaning chamber further includes a gutter arranged to collect the cleaning solution discharged from the discharge unit and falling down without being supplied onto the front surface of the substrate, wherein the gutter is inclined down toward the fine cleaning chamber and includes a drainage vent for draining the cleaning solution flowing through the gutter, wherein the drainage vent of the gutter approaches the fine cleaning chamber across the partition.

As described above, the substrate treatment device according to the present invention has a configuration characterized in that the rough cleaning chamber at the upstream side includes the gutter arranged to collect the cleaning solution discharged from the discharge unit and falling down without being supplied onto the front surface of the substrate, in other words, without touching the front surface of the substrate to which a chemical solution, for example, is adhered, in that the gutter is inclined down toward the fine cleaning chamber and includes the drainage vent for draining the cleaning solution flowing through the gutter, and in that the drainage vent of the gutter approaches the fine cleaning chamber across the partition. Thus, during the time from when an upper end of a substrate being transferred passes by the discharge unit until when a lower end of a following substrate is transferred to the position where the discharge unit is located, the cleaning solution discharged from the discharge unit to fall down can be collected by the gutter and guided to flow into the fine cleaning chamber.

This configuration prevents a thick waste solution that is collected from the drainage vent on the bottom wall of the rough cleaning chamber from being diluted with the cleaning solution that is not supplied onto the front surface of the substrate. Thus, the amount of thick waste solution that needs to undergo a disposal treatment can be decreased. In addition, this configuration allows the cleaning solution that is collected by the gutter to flow into the fine cleaning chamber. Thus, a recyclable diluted waste solution that is collected from the drainage vent on the bottom wall of the fine cleaning chamber can be increased, which can improve use efficiency of the diluted waste solution that is collected from the cleaning chamber.

The configuration is preferably characterized in that the substrate transferring unit includes a plurality of support rollers arranged to support a back surface of the glass substrate, a plurality of transfer rollers arranged to transfer the substrate while supporting a lower end of the substrate, roller axes about which the support rollers are rotatable, and a roller-axis support plate disposed to stand on a back wall of the rough cleaning chamber, including an opening that is disposed above the gutter and allows passage of the cleaning solution falling down on the back wall of the rough cleaning chamber, and supporting, with its front end, intermediate portions of the roller axes. This configuration allows the cleaning solution, which falls down on the back wall of the rough cleaning chamber without being supplied onto the front surface of the substrate, to be collected by the gutter without being blocked by the roller-axis support plate that is provided for preventing the roller axes from getting eccentric.

In addition, the configuration is preferably characterized in that a back end of the gutter is fixed to the back wall of the rough cleaning chamber and a front end of the gutter is fixed to the roller-axis support plate or in that a back end of the gutter is fixed to the back wall of the rough cleaning chamber and a front end of the gutter is fixed to the roller axes by brackets. This configuration allows the gutter to be easily installed in the rough cleaning chamber. In addition, because the front and back ends of the gutter are fixed, the gutter is prevented from being bent due to the weight of the cleaning solution flowing through the gutter.

The configuration is preferably characterized by including a discharge unit arranged to supply a cleaning solution onto the back surface of the substrate. In addition, the configuration is preferably characterized by including a chemical treatment chamber arranged to supply a chemical solution onto the front surface of the substrate, the chemical treatment chamber being disposed at an upstream side of the cleaning chamber, the chemical treatment chamber and the cleaning chamber being partitioned with a partition wall having a slit opening allowing passage of the substrate, and air blowing bars disposed at an upstream side and downstream side of the slit opening of the partition and arranged to issue air to the front surface of the substrate. In addition, the configuration is preferably characterized in that the chemical solution is defined by a removal solution for removing a resist formed on the front surface of the substrate, and in that the cleaning solution is defined by pure water.

### Advantageous Effects of Invention

According to the preferred embodiment of the present invention, having the configuration that during the time from when the upper end of the substrate being transferred passes by the discharge unit until when the lower end of the following substrate is transferred to the position where the discharge unit is located, the cleaning solution discharged from the discharge unit to fall down without being supplied onto the front surface of the substrate can be collected by the gutter and guided to flow into the fine cleaning chamber, the substrate treatment device can prevent the thick waste solution that is collected from the drainage vent on the bottom wall of the rough cleaning chamber from being diluted with the cleaning solution that is not supplied onto the front surface of the substrate to fall down. Thus, the amount of thick waste solution that needs to undergo the disposal treatment can be decreased. In addition, this configuration allows the cleaning solution that is collected by the gutter to flow into the fine cleaning chamber. Thus, the recyclable diluted waste solution that is collected from the drainage vent on the bottom wall of the fine cleaning chamber can be increased, which can improve use efficiency of the diluted waste solution that is collected from the cleaning chamber.

### BRIEF DESCRIPTION OF DRAWINGS

FIG. 1 is a top view showing a schematic configuration of a resist removing device that defines a substrate treatment device according to a preferred embodiment of the present invention.

FIG. 2 is a front view showing a schematic configuration of a cleaning chamber of the resist removing device shown in FIG. 1.

FIG. 3 is a perspective view showing a schematic configuration of the inside of a rough cleaning chamber shown in FIG. 2.

FIG. 4 is a cross-sectional view showing the rough cleaning chamber along the line A-A of FIG. 2.

FIG. 5 is a view showing a schematic configuration of air blowing bars of the resist removing device shown in FIG. 1.

FIG. 6 is a cross-sectional view showing the rough cleaning chamber along the line A-A of FIG. 2, which shows pure water that falls down on a back wall of the rough cleaning chamber and is collected by a gutter.

FIG. 7 is a front view showing a schematic configuration of a cleaning chamber of a conventional resist removing device.

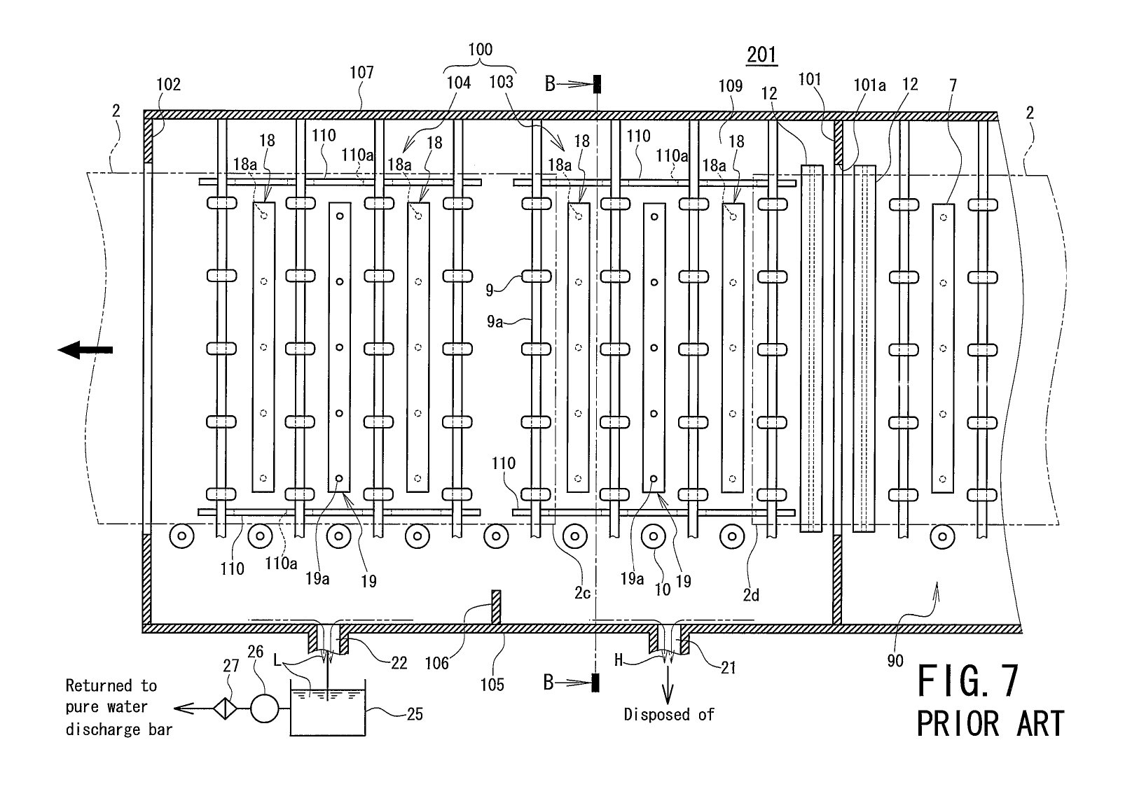

FIG. 8 is a cross-sectional view showing a rough cleaning chamber along the line B-B of FIG. 7.

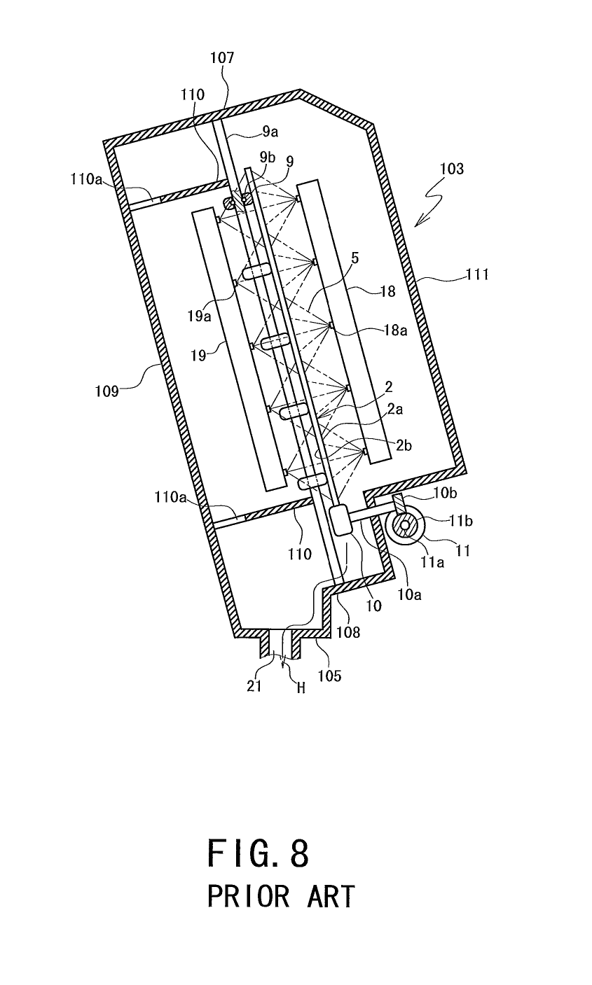

FIG. 9 is a cross-sectional view showing the rough cleaning chamber along the line B-B of FIG. 7, which shows pure water that falls down on a back wall of the rough cleaning chamber.

### DESCRIPTION OF EMBODIMENTS

A detailed description of a preferred embodiment of the present invention will now be provided with reference to the accompanying drawings. In the preferred embodiment of the present invention, a resist removing device that is used in producing a glass substrate for a liquid crystal display panel is used as a substrate treatment device according to the preferred embodiment of the present invention.

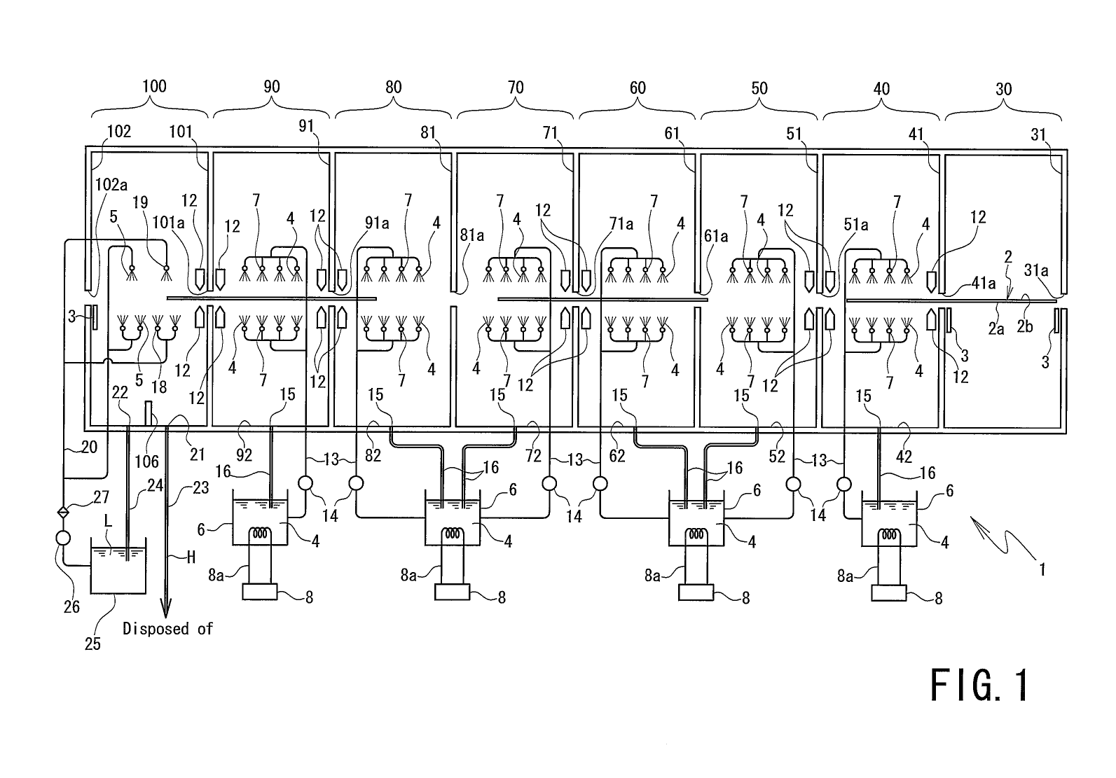

A resist removing device 1 shown in FIG. 1 is arranged to supply a removal solution 4 to a resist formed on front surfaces 2a of glass substrates 2 while transferring the glass substrates 2 that are tilted toward their back surface 2b sides at fifteen degrees to the upright, in other words, at seventy-five degrees from the horizontal direction.

The resist removing device 1 includes a plurality of aligned removal chambers 40 to 90 as show in FIG. 1. The glass substrates 2 are transferred one by one from a neutral chamber 30 to the aligned removal chambers 40 to 90 in sequence, and undergo a resist removal process using the removal solution 4. The removal chambers 40 to 90 are partitioned with partition walls 51 to 91 that have slit openings 51a to 91a respectively allowing passage of a substrate. The neutral chamber 30 and the removal chamber 40 are partitioned with a partition wall 41 that has a slit opening 41a allowing passage of a substrate. The removal chamber 90 and a cleaning chamber 100 are partitioned with a partition wall 101 that has a slit opening 101a allowing passage of a substrate.

A partition wall 31 provided at the upstream side of the neutral chamber 30 includes a slit opening 31a allowing passage of a substrate. The slit openings 31a and 41a at the upstream side and downstream side of the neutral chamber 30 each include shutters 3 that are capable of shutting the slit openings 31a and 41a. A partition wall 102 provided at the downstream side of the cleaning chamber 100 includes a slit opening 102a allowing passage of a substrate. The slit opening 102a includes a shutter 3 that is capable of shutting the slit opening 102a.

Air blowing bars 12 are provided to the removal chambers 40 to 90. High-pressure air is issued from the air blowing bars 12 to remove the removal solution 4 adhered to the front surfaces 2a and back surfaces 2b of the glass substrates 2.

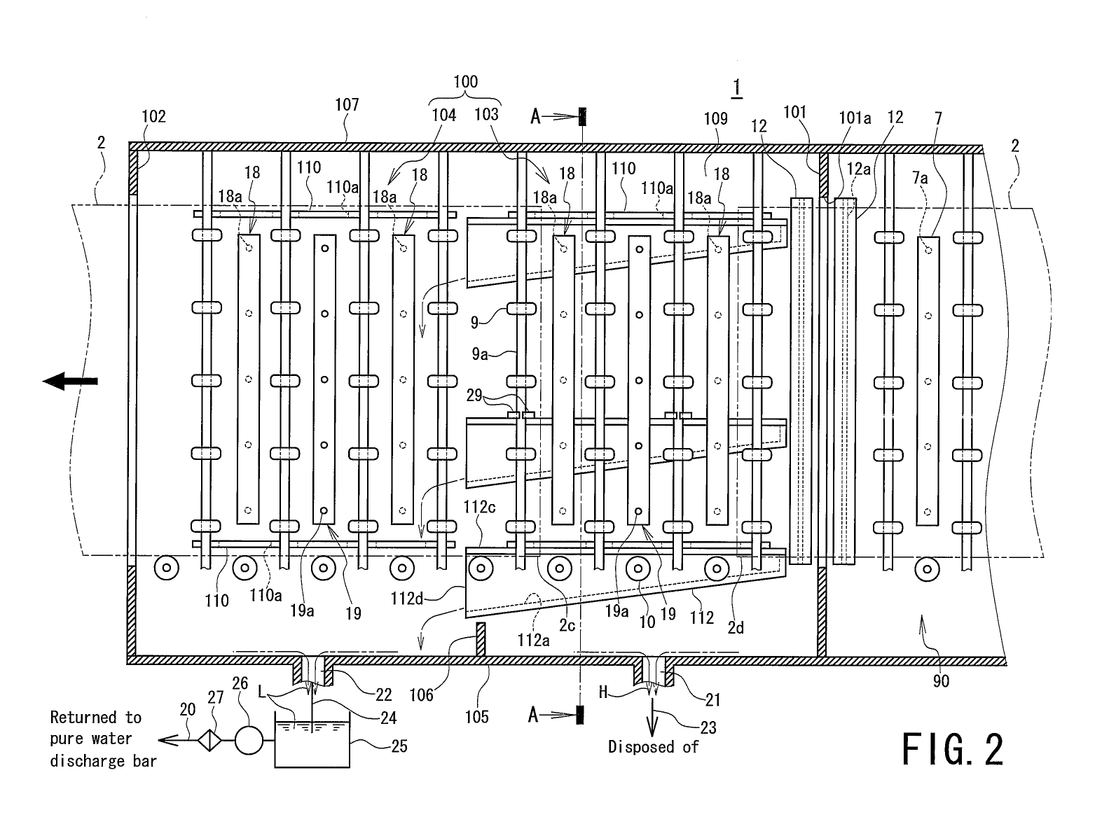

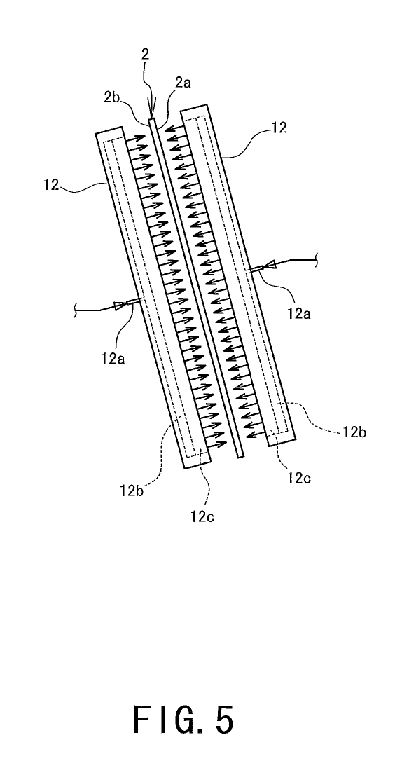

The air blowing bars 12 are disposed perpendicular to a direction in which the glass substrates 2 are transferred, as shown in FIG. 2. Each of the air blowing bars 12 includes an air supply port 12a, an air retaining chamber 12b in which air supplied from the air supply port 12a is once retained, and an air blowing slit opening 12c communicating with the air retaining chamber 12b and arranged to blow air in a linear form to the glass substrates 2, as shown in FIG. 5. An air pump that is not shown is connected to the air supply port 12a of each air blowing bar 12, and compressed air is supplied from the air pump.

The air blowing bars 12 are disposed at the downstream side of the slit opening 91a of the partition wall 91, for example, so that the removal solution 4 that is used in the removal chamber 90 is prevented from getting in the adjacent removal chamber 80. In addition, the air blowing bars 12 are disposed at the upstream side of the slit opening 101a of the partition wall 101, for example, so that the removal solution 4 that is used in the removal chamber 90 is prevented from getting in the adjacent cleaning chamber 100.

In general, the time that the removal solution 4 supplied to the glass substrates 2 requires to remove the resist can be reduced as the temperature of the removal solution 4 is higher, so that the temperature of the removal solution 4 is set high at 80° C. in the removal chambers 40 to 90, for example. The removal solution 4 supplied in the removal chambers 40 to 90 is supplied from reservoirs 6 via pumps 14, and then discharged in a showering manner from removal solution discharge bars 7 to the glass substrates 2.

The reservoirs 6 each include removal solution heating units 8 arranged to heat the removal solution 4. The removal solution heating units 8 each include steam pipes 8a that are used immersed in the removal solution 4, whereby the temperature of the removal solution 4 in the reservoirs 6 is increased to 80° C. High-temperature steam flows in the steam pipes 8a.

The removal solution discharge bars 7 are disposed perpendicular to the transfer direction, as shown in FIG. 2. Each of the removal solution discharge bars 7 includes nozzles 7a, and is arranged to discharge the removal solution 4 in a showering manner from the nozzles 7a onto the front surfaces 2a and back surfaces 2b of the glass substrates 2. The removal solution discharge bars 7 are disposed at given intervals in the transfer direction. The removal solution discharge bars 7 are connected to the reservoirs 6 by removal solution supply pipes 13 as shown in FIG. 1. Thus, the removal solution 4 is sent to the removal solution discharge bars 7 by the pumps 14.

Filters for filtering the removal solution 4 that flows through the removal solution supply pipes 13, and valves for regulating the flow of the removal solution 4, which are not shown, are provided to the removal solution supply pipes 13 between the pumps 14 and the removal solution discharge bars 7.

The removal chambers 40 to 90 each include drainage vents 15 on their bottom walls 42 to 92. The drainage vents 15 are connected to the reservoirs 6 via drainage tubes 16. The removal solution 4 collected through the drainage tubes 16 is once reserved in the reservoirs 6, and is returned to the removal solution discharge bars 7 by the pumps 14.

The air in the removal chambers 40 to 90 is forced out of exhaust holes provided on upper walls of the removal chambers 40 to 90 by exhaust means, the exhaust holes and the exhaust means not shown. The exhaustion of the removal chambers 40 to 90 allows vapors or mists from the removal solution 4 that spread in the upper portions of the removal chambers 40 to 90 to be exhausted therefrom. The exhaustion is performed so that the vapors or mists from the removal solution 4 do not escape from the removal chambers 40 to 90 to the outside because a chemical solution that is toxic to human bodies is usually used for the removal solution 4.

In addition, the exhaustion is performed so that the vapors or mists from the removal solution 4 that is used in the removal chamber 90 and foreign substances contained in the vapors or mists do not escape to the adjacent removal chamber 80 or the adjacent cleaning chamber 100. If foreign substances are generated in a specific removal chamber and get in another removal chamber or the cleaning chamber 100, the whole resist removing device 1 requires maintenance.

Then, the glass substrates 2 having passed through the removal chambers 40 to 90 are transferred to the cleaning chamber 100. In the cleaning chamber 100, the front surfaces 2a and back surfaces 2b of the glass substrates 2 are rinsed in pure water 5. Then, the glass substrates 2 are air-dried in a drying chamber, which is not shown.

As shown in FIG. 2, the cleaning chamber 100 includes a rough cleaning chamber 103 at the upstream side and a fine cleaning chamber 104 at the downstream side, which are partitioned with a partition 106 provided to stand on a bottom wall 105. Each of the cleaning chambers 103 and 104 includes two pure water discharge bars 18 disposed at the front side that are arranged to supply the pure water 5 onto the front surfaces 2a of the glass substrates 2, and one pure water discharge bar 19 disposed at the back side that is arranged to supply the pure water 5 onto the back surfaces 2b of the glass substrates 2. A plurality of nozzles 18a and 19a that are arranged to discharge the pure water 5 in a showering manner are provided to the pure water discharge bars 18 and 19, respectively.

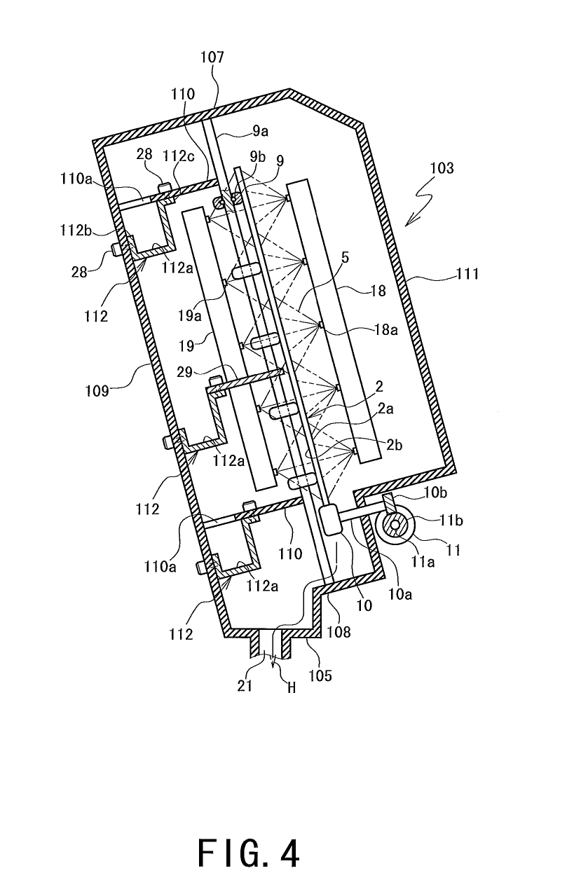

As shown in FIG. 4, the pure water discharge bars 18 at the front side are disposed opposed to the front surfaces 2a of the glass substrates 2, and the pure water discharge bars 19 at the back side are disposed opposed to the back surfaces 2b of the glass substrates 2. As shown in FIG. 2, in each of the cleaning chambers 103 and 104, the one pure water discharge bar 19 at the back side is disposed between the two pure water discharge bars 18 at the front side.

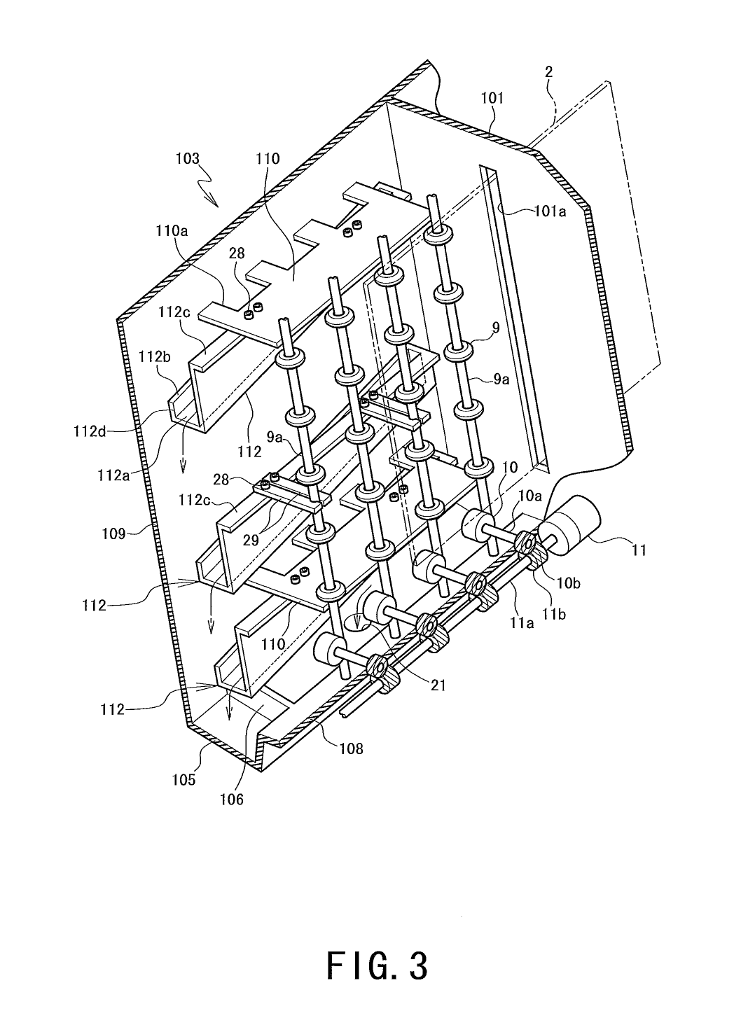

In addition, each of the cleaning chambers 103 and 104 includes support rollers 9, which are arranged to support the back surfaces 2b of the glass substrates 2, and transfer rollers 10 disposed in the transfer direction, which are arranged to transfer the glass substrates 2 while supporting the lower ends of the glass substrates 2, as shown in FIGS. 3 and 4. It is to be noted that FIG. 3 is a perspective view where the air blowing bars 12, the pure water discharge bars 18 at the front side, and the pure water discharge bar 19 at the back side are not shown for the sake of simplicity.

The support rollers 9 are disposed at the back surface 2b sides that are under the tilted glass substrates 2. The axes of the support rollers 9 are tilted so as to be parallel to the glass substrates 2 being transferred, in other words, tilted at seventy-five degrees. As shown in FIG. 4, the support rollers 9 are rotatable about roller axes 9a by ball bearings 9b. The upper ends and lower ends of the roller axes 9a are fixed to an upper wall 107 and lower wall 108 of the cleaning chamber 100. The roller axes 9a are disposed at given intervals in the transfer direction.

Intermediate portions of the roller axes 9a are supported by the front ends of roller-axis support plates 110 that are disposed to stand on a back wall 109 of the cleaning chamber 100. Thus, the roller axes 9a are prevented from getting eccentric, whereby the roller axes 9 are not decentered during the transfer of the substrates 2. Each of the roller-axis support plates 110 includes a plurality of openings 110a that allow passage of the pure water 5 falling down on the back wall 109 of the cleaning chamber 100.

As shown in FIG. 3, the transfer rollers 10 arranged to support the lower ends of the glass substrates 2 are fixed to one ends of drive axes 10a. Gears 10b are attached to the other ends of the drive axes 10a. Gears 11b having a configuration to engage with the gears 10b are attached to rotational axes 11a of motors 11. Rotary driving the transfer rollers 10 by the use of the motors 11 generates a friction force between the transfer rollers 10 and the lower ends of the glass substrates 2, which allows the glass substrates 2 to be transferred.

The rough cleaning chamber 103 includes a drainage vent 21 on the bottom wall 105. In the rough cleaning chamber 103, the removal solution 4 that is adhered to the glass substrates 2 transferred from the adjacent removal chamber 90 is mixed with the pure water 5 in which the removal solution 4 is rinsed, and a thick waste solution H is produced. The thick waste solution H is drained out of the drainage vent 21.

A drainage tube 23 for thick waste solution is connected to the drainage vent 21 of the rough cleaning chamber 103 as shown in FIG. 1. The thick waste solution H collected through the drainage tube 23 is made into powdery wastage and disposed of in a disposing facility equipped with a boiler.

The fine cleaning chamber 104 includes a drainage vent 22 on the bottom wall 105. In the fine cleaning chamber 104, because the removal solution 4 that gets in from the adjacent removal chamber 90 has been already removed to some extent in the rough cleaning chamber 103, a diluted waste solution L that is a mixture of the removal solution 4 and the pure water 5 where the mixing ratio of the removal solution 4 is low is produced. The diluted waste solution L is drained out of the drainage vent 22.

A drainage tube 24 for diluted waste solution is connected to the drainage vent 22 of the fine cleaning chamber 104 as shown in FIG. 1. The diluted waste solution L is collected into a recovery tank 25 via the drainage tube 24. The diluted waste solution L collected into the recovery tank 25 is cleaned there preferably by bacteria, and returned to the pure water discharge bars 18 and 19 via a pump 26, a filter 27 and a pure water supply pipe 20.

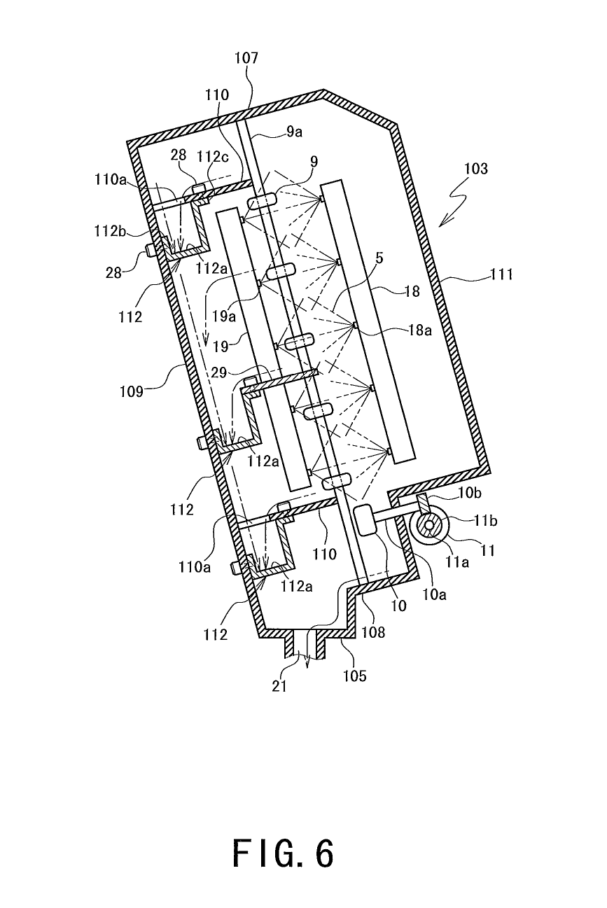

The rough cleaning chamber 103 includes gutters 112 arranged to collect the pure water 5 that is discharged from the pure water discharge bars 18 at the front side and falls down on the back wall 109 of the rough cleaning chamber 103 without being supplied onto the front surfaces 2a of the glass substrates 2, in other words, without touching the front surfaces 2a of the glass substrates 2 to which the removal solution 4 is adhered, as shown FIG. 6. The gutters 112 are inclined down toward the fine cleaning chamber 104.

To be specific, the gutters 112 are provided in order to dam the pure water 5 that is discharged from the pure water discharge bars 18 at the front side and falls down on the back wall 109 of the rough cleaning chamber 103, preventing the pure water 5 from directly flowing into the drainage vent 21 on the bottom wall 105, during the time from when upper ends 2c of the glass substrates 2 pass by the pure water discharge bars 18 at the front side until when lower ends 2d of the following glass substrates 2 are transferred to the position where the pure water discharge bars 18 at the front side are located, as shown in FIG. 2. Thus, the gutters 112 can collect the pure water 5 falling down on the back wall 109 of the rough cleaning chamber 103, guiding the collected pure water 5 to the fine cleaning chamber 104.

The gutters 112 are disposed below the top roller-axis support plate 110, below the bottom roller-axis support plate 110, and between the top roller-axis support plate 110 and the bottom roller-axis support plate 110.

The gutters 112 are made of metal plate, and bent so as to have the shape of the letter L in cross section. The gutters 112 each include bottom portions 112a that are inclined down toward the fine cleaning chamber 104 at the downstream side.

The gutters 112 each include back-side attaching portions 112b disposed at the back ends of the bottom portions 112a, protruding upward. The back-side attaching portions 112b are fixed to the back wall 109 of the rough cleaning chamber 103 by retaining screws 28. In addition, the gutters 112 each include front-side attaching portions 112c disposed at the front ends of the bottom portions 112a, protruding toward the front side.

The front-side attaching portions 112c of the gutters 112 disposed below the top roller-axis support plate 110 and disposed below the bottom roller-axis support plate 110 are fixed to the roller-axis support plates 110 by retaining screws 28.

The front-side attaching portion 112c of the gutter 112 between the top roller-axis support plate 110 and the bottom roller-axis support plate 110 is fixed to the roller axes 9a by brackets 29. To be specific, the front-side attaching portion 112c is fixed to the roller axes 9a by the brackets 29 such that the front-side attaching portion 112c is fixed to the back ends of the brackets 29 by retaining screws 28 while the front ends of the brackets 29 pinch the roller axes 9a.

This configuration allows the gutters 112 to be easily installed on the back wall 109 of the rough cleaning chamber 103. In addition, because the front and back ends of the gutters 112 are fixed, the gutters 112 are prevented from being bent due to the weight of the pure water 5 flowing through the gutters 112.

The ends at the upstream side of the gutters 112 are closed. The other ends at the downstream side of the gutters 112 are each provided with drainage vents 112d. The gutters 112 have a length longer than the roller-axis support plates 110. The ends at the upstream side of the gutters 112 are disposed at the more upstream side of the ends at the upstream side of the roller-axis support plates 110. The ends at the downstream side of the gutters 112 are disposed at the more downstream side of the ends at the downstream side of the roller-axis support plates 110. This configuration allows the gutters 112 to collect not only the pure water 5 falling down from the openings 110a of the roller-axis support plates 110, but also the pure water 5 that overflows to fall down from the ends at the upstream side of the roller-axis support plates 110 and the pure water 5 that overflows to fall down from the ends at the downstream side of the roller-axis support plates 110.

The drainage vents 112d of the gutters 112 are disposed so as to approach the fine cleaning chamber 104 across the partition 106 as shown in FIGS. 2 and 3. This configuration allows the pure water 5 flowing through the gutters 112 to fall down on the bottom wall 105 of the fine cleaning chamber 104.

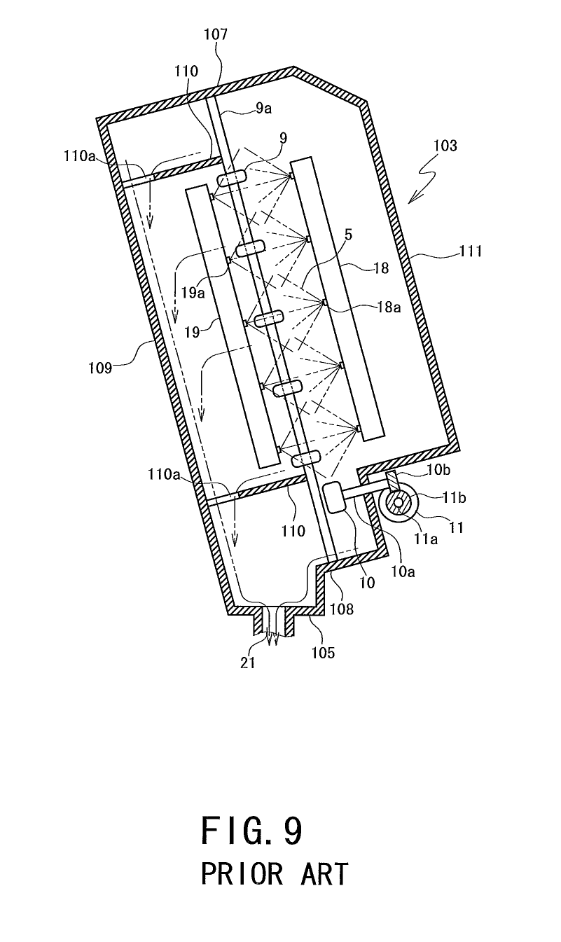

The pure water 5 discharged from the pure water discharge bars 18 at the front side, which are disposed opposed to the front surfaces 2a of the glass substrates 2 tilted toward their back surface 2b sides at some degrees to the upright as shown in FIG. 4, is directly splashed to fall down on the back wall 109 of the rough cleaning chamber 103 after the glass substrates 2 have passed by the pure water discharge bars 18 as shown in FIG. 6. However, dammed by the gutters 12, the pure water 5 that falls down on the back wall 109 can be prevented from being drained out of the drainage vent 21 on the bottom wall 105 of the rough cleaning chamber 103, which cannot be prevented in the conventional substrate treatment device shown in FIG. 9.

Thus, the thick waste solution H collected from the drainage vent 21 on the bottom wall 105 of the rough cleaning chamber 103 is not diluted with the pure water 5 that falls down on the back wall 109 without being supplied onto the front surfaces 2a of the glass substrates 2. Therefore, the amount of the thick waste solution H that needs to undergo a disposal treatment can be decreased, which can reduce the disposal cost.

In addition, because the pure water 5 that falls down on the back wall 109 of the rough cleaning chamber 103 is collected by the gutters 112 and guided to flow into the fine cleaning chamber 104, the recyclable diluted waste solution L that is collected from the drainage vent 22 on the bottom wall 105 of the fine cleaning chamber 104 can be increased, which can improve use efficiency of the diluted waste solution L that is collected from the cleaning chamber 100.

The foregoing description of the preferred embodiment of the present invention has been presented for purposes of illustration and description with reference to the drawings. However, it is not intended to limit the present invention to the preferred embodiment, and modifications and variations are possible as long as they do not deviate from the principles of the present invention.

1. A substrate treatment device that comprises a cleaning chamber, the cleaning chamber comprising:
a substrate transferring unit arranged to transfer a substrate while keeping the substrate tilted toward a back surface side of the substrate at a given degree to the upright; and
a cleaning solution discharge unit arranged to supply a cleaning solution onto a front surface of the substrate being transferred by the substrate transferring unit,
wherein the cleaning chamber is partitioned into:
a rough cleaning chamber at an upstream side that comprises a drainage vent disposed on a bottom wall of the rough cleaning chamber; and
a fine cleaning chamber at a downstream side that comprises a drainage vent provided on a bottom wall of the fine cleaning chamber, with a partition provided to stand on the bottom wall of the cleaning chamber,
wherein the rough cleaning chamber further comprises a gutter arranged to collect the cleaning solution discharged from the discharge unit and falling down without being supplied onto the front surface of the substrate,
wherein the gutter is inclined down toward the fine cleaning chamber, and comprises a drainage vent for draining the cleaning solution flowing through the gutter,
wherein the drainage vent of the gutter approaches the fine cleaning chamber across the partition.

2. The substrate treatment device according to claim 1, wherein the substrate transferring unit comprises:
a plurality of support rollers arranged to support a back surface of the substrate;
a plurality of transfer rollers arranged to transfer the substrate while supporting a lower end of the substrate;
roller axes, about which the support rollers are rotatable; and
a roller-axis support plate disposed to stand on a back wall of the rough cleaning chamber, comprising an opening that is disposed above the gutter and allows passage of the cleaning solution falling down on the back wall of the rough cleaning chamber, and supporting, with its front end, intermediate portions of the roller axes.

3. The substrate treatment device according to claim 2, wherein a back end of the gutter is fixed to the back wall of the rough cleaning chamber, and a front end of the gutter is fixed to the roller-axis support plate.

4. The substrate treatment device according to claim 2, wherein a back end of the gutter is fixed to the back wall of the rough cleaning chamber, and a front end of the gutter is fixed to the roller axes by brackets.

5. The substrate treatment device according to claim 1, further comprising a cleaning solution discharge unit arranged to supply a cleaning solution onto the back surface of the substrate.

6. The substrate treatment device according to claim 1, further comprising:
a chemical treatment chamber arranged to supply a chemical solution onto the front surface of the substrate, the chemical treatment chamber being disposed at an upstream side of the cleaning chamber, the chemical treatment chamber and the cleaning chamber being partitioned with a partition wall comprising a slit opening allowing passage of the substrate; and
air blowing bars disposed at an upstream side and downstream side of the slit opening of the partition, and arranged to issue air to the front surface of the substrate.

7. The substrate treatment device according to claim 6, wherein the chemical solution comprises a removal solution for removing a resist formed on the front surface of the substrate.

8. The substrate treatment device according to claim 1, wherein the cleaning solution comprises pure water.
